(19) United States
(12) Patent Application Publication
(10) Pub. No.: US 2011/0040999 A1
(43) Pub. Date: Feb. 17, 2011

(54) TICK SOURCE

(76) Inventors: Michael Joseph Pont, Leicestershire (GB); Zemian Mark Hughes, Cambridgeshire (GB)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/599,800

(22) PCT Filed: May 9, 2008
(86) PCT No.: PCT/GB08/01599

§ 371 Date: Sep. 24, 2010

(30) Foreign Application Priority Data
May 11, 2007 (GB) 0709097.0

(51) Int. Cl. G06F 1/08

(52) U.S. Cl. 713/502; 713/500

(57) ABSTRACT

A tick source device (10) configured to accept a plurality of input signals and then to select one of said plurality of input signals and to use said one of said plurality of input signals as a source to generate a single output signal (12) to drive a processing device. A method of generating a signal to drive a processing device in accordance with the above is also disclosed.

### FIELD OF THE INVENTION

This invention relates to a tick source. Particularly, but not exclusively, the invention relates to a tick source hardware platform that is suitable for use in time-triggered systems.

### BACKGROUND TO THE INVENTION

Embedded processors are ubiquitous: they form a core component of a vast range of everyday items (cars, aircraft, medical equipment, factory systems, mobile phones, DVD players, music players, microwave ovens, toys etc). In some cases several embedded processors may be employed, each for a specific function. For example, a typical modern car may contain around fifty embedded processors.

In applications where safety is an important consideration—such as in automotive systems, aerospace systems and medical systems—it is vital that a reliable processor is used and that it operates in a highly predictable manner. For instance, when a driver presses the brake pedal on a car, he/she needs to be assured that the related processor will operate within an appropriate time-interval to initiate slowing the car. Thus, in safety-related or safety-critical applications it is important that a processor with a predictable timing feature is used.

In addition, for embedded applications without direct safety concerns—such as in brown or white goods like televisions or washing machines—predictable behaviour may help to improved system reliability, thereby reducing maintenance and/or repair costs (and inconvenience to the user) during the operational life of the device.

Over recent years, the issue of reliability in embedded systems has been addressed in various ways by employing time-triggered software solutions. The Applicants have themselves been involved in creating such software for industry-standard hardware platforms such as the 8051 micro-controller, ARM™ processor and PC platform. Developing reliable applications using this approach can be effective, but there is a mismatch between generic processor architectures and time-triggered software designs. For example, most processors support a wide range of interrupts, while the use of a (pure) time-triggered software architecture generally requires that only a single interrupt can be supported by each processor. This leads to software design ‘guidelines’, like the ‘one interrupt per micro-controller rule’. Such guidelines can be adhered to by use of appropriate tools in software creation. However, it is possible that developers of time-triggered software designs (or people who subsequently maintain or upgrade systems based on time-triggered software designs) may be unaware of the need to employ only a single interrupt source with such designs. If, as a result of this lack of knowledge or lack of experience, an attempt is made to use multiple interrupts in such systems, this may lead to highly unpredictable behaviour.

It is therefore an object of the present invention to provide a solution that alleviates the aforementioned problems.

### SUMMARY OF THE INVENTION

According to a first aspect of the present invention there is provided a tick source device configured to accept a plurality of input signals, to select one of said plurality of input signals, and to use said one of said plurality of input signals as a source to generate a single output signal to drive a processing device.

Conveniently, all of the above functionality may be embedded in hardware. Thus, the present invention can ensure that it is not possible to enable, i.e. by means of software, more than one signal (i.e. interrupt or clock ‘tick’) to drive a particular processor. Accordingly, the present invention helps to reduce the opportunities for coding or design errors, which, if uncorrected, could lead to unpredictable system behaviour. More specifically, the present invention ensures that only a single stable signal is provided to regulate the execution of processing tasks. At the same time, the device can ensure that input signals that are not being utilised to drive the processing device cannot be used to generate additional interrupts.

It will be understood that the plurality of input signals may be provided from a plurality of sources.

In a preferred embodiment, at least the selected one of said plurality of input signals is a periodic input signal. Furthermore, it is preferable that the single output signal is a periodic output signal.

The device according to the first aspect of the invention may be utilised in a system employing time-triggered architecture, for example, to drive a time-triggered cooperative hardware scheduler or a general-purpose processor running time-triggered scheduler software.

In an embodiment of the first aspect of the present invention, the input signals, which are not selected as the source to generate the single output signal, are ‘polled’ (i.e. their status is checked on a regular basis) under the control of a system scheduler.

In a preferred embodiment of the first aspect of the invention, the device may be configured to select, by default, a periodic input signal from an on chip timer as the source used to generate the single periodic output signal.

The device may be configured such that a user can manually select the input signal that is to be used as the source. This may either be through software settings or (in a system-on-chip design) through changes to the hardware architecture. Where it is possible for a user to make such configuration changes, it may not be possible for the user to enable more than one source (i.e. interrupt) to drive the processor under normal operating conditions.

The identification of the source used to generate the single periodic output signal may be stored in a register.

The single periodic output signal may be set, by default, to generate ‘ticks’ (i.e. interrupts) every 1 ms. This is a common tick rate used in time-triggered architectures.

The device may be configured such that a user can set the single periodic output signal to generate ‘ticks’ at a desired rate.

In a particular embodiment of the first aspect of the invention, at least one of said plurality of input signals is derived from an on-chip timer. Alternatively, or additionally, at least one of said plurality of input signals is provided via a suitable communication bus such as a Controller Area Network (CAN) bus or a Universal Asynchronous Receiver & Transmitter (UART) bus.

In another embodiment of the first aspect of the invention, the device is configured to change the source used to generate the single output signal upon detection of an error in the selected input signal. For example, if the current source of ticks is from a CAN bus and it is determined that signals are no longer being received from this bus, the device may change the source of output ticks to a (on-chip) timer. Preferably, the device is configured so as to notify the processor of any such change, for example, by means of an error or tick-source register.

The device may be configured as a field programmable gate array (FPGA) or a custom-designed chip such as an application-specific integrated circuit (ASIC).

Where an implementation on a FPGA is employed (created using, for example, VHDL), it may be possible for the user to alter the hardware design and—thereby—circumvent the protection provided by the tick source device of the present invention. In such designs, a simple checking procedure can be carried out to ensure that the tick source device is complete and (in particular) that no changes have been made to allow the use of more than one interrupt.

According to a second aspect of the present invention there is provided an apparatus, machine or vehicle employing a tick source device according to the first aspect of the present invention.

The second aspect of the present invention may further comprise a processor configured to be driven by only the tick source device according to the first aspect of the present invention (i.e. not permitting any other sources of interrupts to drive the processor). In this particular embodiment, the processor may include a mechanism for polling the status of other interrupts, for example by means of a periodic task executed by a system scheduler.

According to a third aspect of the present invention there is provided a method of driving a processing device comprising the steps of: detecting a plurality of input signals; selecting one of said plurality of input signals; and generating a single output signal, from said one of said plurality of input signals, to drive the said processing device.

Preferably, at least the selected one of said plurality of input signals is a periodic input signal and the single output signal is a periodic output signal.

### BRIEF DESCRIPTION OF THE DRAWINGS

Particular embodiments of the present invention will now be described with reference to the accompanying drawings, in which:

FIG. 1A illustrates schematically the functionality of a tick source device according to the present invention;

FIG. 1B shows a logic diagram for a particular embodiment of a tick source device according to the present invention; and

FIG. 2 illustrates schematically a ‘Status’ Register and a ‘Cause’ Register as employed in an embodiment of the present invention.

### DETAILED DESCRIPTION OF CERTAIN EMBODIMENTS

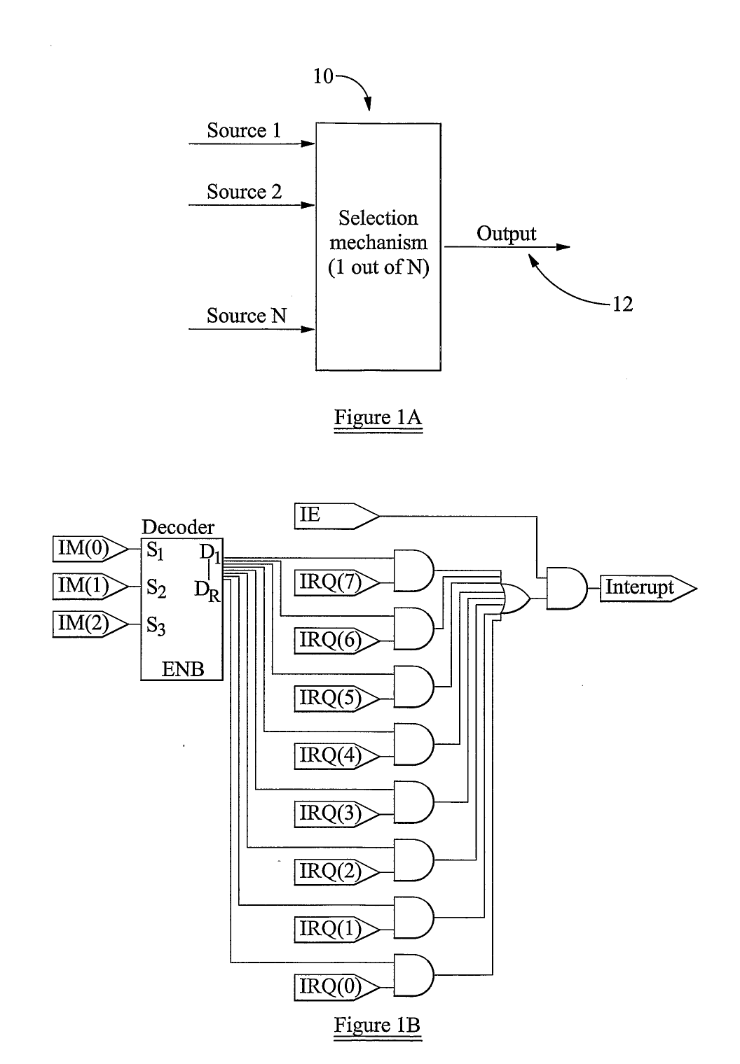

FIG. 1A illustrates the functionality of a tick source (timer) device 10 according to the present invention. As illustrated, the timer device 10 is capable of receiving a number (N) of source signals. In this particular example, source 1 is a conventional (on-chip) timer, source 2 is a piece of UART hardware and source N is a piece of CAN hardware. Each source provides an input signal, to the timer device 10, which is in the form of a series of periodic ticks. The timer device 10 then selects one of the various input signals and uses that signal as the source for generating a single periodic output signal 12. This output signal can then be used to drive a processing device (not shown).

By restricting the number of possible interrupt sources in a time-triggered system to 1, it is possible to enforce a ‘one interrupt per microcontroller’ design guideline. Consequently, the timer device 10 of the present invention provides a hardware platform that can be employed in a time-triggered architecture to ensure that only one source of ticks is used to drive the processor. This ensures that the behaviour of the system is more predictable.

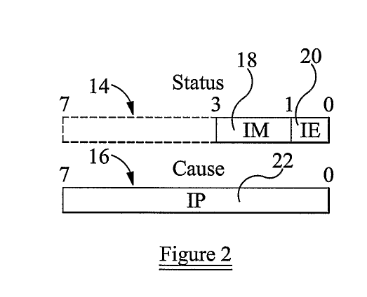

FIG. 1B shows a logic diagram for a particular embodiment of a tick source device according to the present invention. In this case, a FPGA was designed using VHDL. This device permits the selection of a single output source (interrupt) from up to 8 possible tick sources. The operation of such a device is as described below, with reference to FIG. 2.

In a particular embodiment of the invention, the Applicants implemented the timer device of the present invention in the first of four optional coprocessor devices (coprocessor 0) that are connected to a PH processor. The PH processor is a design of processor that follows the outline provided by Patterson and Hennessy (Patterson, D. A. and Hennessy, J. L. (2004) “Computer Organization and Design: The Hardware/Software Interface”, 3^{rd} Edition.Elsevier/Morgan-Kaufmann.ISBN:1-55860-604-1). The PH processor is a 32-bit design with 32 registers and a 5-stage pipeline. The processor includes a multiplier and divider and a cut down version of the system coprocessor CPo. Coprocessor 0 forms part of the internal processor core. It includes registers, as listed in Table 1 below, which are derived from a MIPS core.

TABLE 1

| Register Number | Register Name |
|---|---|
| R12 | Status |
| R13 | Cause |
| R14 | Exception Program Counter (EPC) |
| R15 | Processor ID (PRId) |
| R16 | Config |

The coprocessor 0 uses the register names found in a known MIPS processor. However, the structure and operation of the registers in the coprocessor 0, according to the present invention, are significantly different.

Of particular interest to the present invention is the Status register 14 and the Cause register 16, as illustrated in FIG. 2. In this particular embodiment, the EPC and the PRId registers are the same as in a MIPS processor but with the PRId register containing version numbers relating to the PH processor. The Config register has a low power bit (only) and this is used to place the processor in an idle/sleep mode.

In order to enforce the one interrupt rule with multiple sources, the Interrupt Mask (IM) register 18 in the Status register 14 holds the binary number for the source to be enabled. In this particular example, there are 8 possible sources and so the IM register 18 is only 3 bits wide. Of course, if more or less possible sources were provided, the IM register 18 could be sized accordingly.

In operation, the timer device 10 takes the binary number from the IM register 18 and runs it through a 3 to 8 bit decoder wherein each of the 8 bits represents one of the 8 sources and only the bit corresponding to the desired source number is set high. This ensures that it is not possible to select more than one source. Each of the 8 bits is then passed through an AND gate with its respective source signal so that the output will be high when the input signal is high from the chosen source. Assuming the Interrupt Enable (IE) bit 20 in the Status register 14 is set, the signal from the chosen source will be passed through to the PH processor as the only interrupt source.

In this particular embodiment of the invention, all of the sources are configured to be flagged in a pending register if they produce a high input signal at any point. Such a pending register can then be read by a polling application (i.e. under control of a scheduler). Once the application has read the results in the pending register, any pending flags can be reset.

The main difference in operation of the above system, as compared to previous known systems, is that it is not possible to accidentally enable more than one tick source at any one time. Since only one source can be enabled there is also no need for an interrupt priority mechanism.

To access the registers in the coprocessor 0 detailed above, the special coprocessor instructions that are provided in the PH processor, i.e. ‘Move to System Control Coprocessor’ (MTC0) and ‘Move from System Control Coprocessor’ (MFS0), should be used. However, this is not simply a question of writing to a memory location since these specific instructions are required to read and write to the registers in the coprocessor 0. The following macros were used in the above embodiment to make this process simpler in the C programming language.

#define CP0ReadStatus( ) ({ tLong _tmp_{——}; asm volatile(“mfc0 %0, $12” : “=d” (_tmp_{——}) :); _tmp_{——}; })
#define CP0ReadCause( ) ({ tLong _tmp_{——}; asm volatile(“mfc0 %0, $13” : “=d” (_tmp_{——}) :); _tmp_{——}; })
#define CP0ReadEPC( ) ({ tLong _tmp_{——}; asm volatile(“mfc0 %0, $14” : “d” (_tmp_{——}) : ); _tmp _{——}; })
#define CP0ReadPRId( ) ({ tLong _tmp_{——}; asm volatile(“mfc0 %0, $15” : “=d” (_tmp_{——}) :); _tmp_{——}; })
#define CP0ReadConfig( ) ({ tLong _tmp_{——}; asm volatile(“mfc0 %0, $16” : “=d” (_tmp_{——}) :); _tmp_{——}; })
#define CP0WriteStatus(value) ({ asm volatile(“mtc0 %0, $12” :: “d” ((tLong) (value))); })
#define CP0WriteCause(value) ({ asm volatile(“mtc0 %0, $13” :: “d” ((tLong) (value))); })
#define CP0WriteConfig(value) ({ asm volatile(“mtc0 %0, $16” :: “d” ((tLong) (value))); })
#define Sleep( ) CP0WriteConfig(1);
#define EnableInt( ) CP0WriteStatus(CP0ReadStatus( ) | 1);
#define DisableInt( ) CP0WriteStatus(CP0ReadStatus( ) & ~1);
#define EnableIRQ(value) CP0WriteStatus(CP0ReadStatus( ) | (value << 1));

When specifying which interrupt source to enable the “EnableIRQ( )” function is called where the number passed to the function represents the interrupt source that will be enabled. For instance, as shown below, the function is called enabling the 7^{th} interrupt source. This function places the source number into the IM (Interrupt Mask) 18 portion of the Status register 14. In this particular embodiment of the invention, the designer or user decides which source they wish to enable at a particular time by using the EnableIRQ function. However, in other embodiments the source may be pre-programmed or selected based on the strength of the input signals received.

EnableIRQ(7);

A global IE (Interrupt Enable) flag 20 in the Status register 14 is also set in order to allow the interrupt source to have effect on the PH processor, this is done by calling the “EnableInt( )” function.

EnableInt( );

All interrupt sources are flagged in the IP (Interrupt Pending) 22 part of the Cause register 16. Each bit represents each interrupt source and a ‘1’ indicates that an interrupt has occurred on that source. This register can be read by the following function call.

CP0ReadCause( );

Writing a ‘1’ to the Cause register 16 for the desired pending bit will reset that pending bit back to zero. The register can be written to by the following function call.

CP0WriteCause(value);

Thus, as described above, a tick source device according to an embodiment of the present invention can be employed to permit only a single interrupt to pass to a processor.

In a time-triggered architecture, a periodic source of ticks drives the processor in the sense that it regulates the processor time so that it may execute one or more periodic tasks. According to the present invention, these ticks may be obtained from one (but only one) of a number of different sources, depending on the nature of the system. The fact that the present invention only allows one of a number of possible sources to drive the processor, means that the possibility of conflicting drive signals is eliminated and the processor behaviour is much more predictable.

Use of the present invention simplifies the process of implementing a time-triggered scheduler in an embedded system. It also reduces the opportunities for coding errors that can make the system behaviour much less easy to predict. Thus, use of this invention can result in the creation of embedded systems with more predictable patterns of behaviour.

It will be appreciated by persons skilled in the art that various modifications may be made to the above-described embodiments without departing from the scope of the present invention. For example, whilst the above discussion has been primarily concerned with embedded systems, the invention is equally applicable to other applications where the timing of events is important.

1. A tick source device configured to accept a plurality of input signals, to select one of said plurality of input signals, and to use said one of said plurality of input signals as a source to generate a single output signal to drive a processing device.

2. The tick source device according to claim 1 wherein the plurality of input signals is provided from a plurality of sources.

3. The tick source device according to claim 1 wherein at least the selected one of said plurality of input signals is a periodic input signal and/or the single output signal is a periodic output signal.

4. (canceled)

5. The tick source device according to claim 1 configured to drive a time-triggered cooperative hardware scheduler or a general-purpose processor running time-triggered scheduler software.

6. The tick source device according to claim 1 wherein the input signals, which are not selected as the source to generate the single output signal, are polled by a system scheduler.

7. The tick source device according to claim 1 wherein the device is configured to select a periodic input signal from an on chip timer as the source used to generate the single periodic output signal or is configured such that a user can manually select the input signal that is to be used as the source.

8. (canceled)

9. The tick source device according to claim 7 wherein the user can select the input signal through software settings and, optionally, the user is prevented from enabling more than one input signal to drive the processing device at any one time.

10. The tick source device according to claim 7, wherein the user can select the input signal through changes to the hardware architecture.

11. (canceled)

12. The tick source device according claim 1 wherein the identification of the source used to generate the single periodic output signal is stored in a register.

13. The tick source device according to claim 1 wherein the single periodic output signal is set to generate ticks every 1 ms.

14. The tick source device according to claim 1 wherein the device is configured such that a user can set the single periodic output signal to generate ticks at a desired rate.

15. The tick source device according to claim 1 wherein at least one of said plurality of input signals is derived from an on-chip timer or provided via a Controller Area Network (CAN) bus or a Universal Asynchronous Receiver & Transmitter (UART) bus.

16. (canceled)

17. The tick source device according to claim 1 wherein the device is configured to change the source used to generate the single output signal upon detection of an error in the selected input signal and, optionally, the device is configured to notify the processor of a change in the source used to generate the single output signal.

18. (canceled)

19. The tick source device according to claim 1 wherein the device is configured as a field programmable gate array (FPGA).

20. The tick source device according to claim 19 further comprising a checking means capable of performing a procedure to ensure that no changes have been made to the tick source device to allow the generation of more than one output signal.

21. An apparatus, machine or vehicle employing a tick source device according to claim 1.

22. The apparatus, machine or vehicle according to claim 21 further comprising a processor configured to be driven only by the tick source device.

23. The apparatus, machine or vehicle according to claim 22, wherein the processor includes a mechanism for polling the status of other input signals.

24. A method of generating a signal to drive a processing device comprising the steps of:
detecting a plurality of input signals;
selecting one of said plurality of input signals; and
generating a single output signal, from said one of said plurality of input signals, to drive the said processing device.

25. The method of claim 24 wherein at least the selected one of said plurality of input signals is a periodic input signal and the single output signal is a periodic output signal.

26-28. (canceled)
